(19) United States
(12) Patent Application Publication
(10) Pub. No.: US 2016/0312465 A1
(43) Pub. Date: Oct. 27, 2016

(54) AIR CONDITIONER PLATFORM

(71) Applicant: Tony J. Azar, Ontario (CA)

(72) Inventor: Tony J. Azar, Ontario (CA)

(21) Appl. No.: 15/133,569

(22) Filed: Apr. 20, 2016

(30) Foreign Application Priority Data
Apr. 24, 2015 (CA) 2 889 431

(51) Int. Cl. E04B 7/18; F16M 13/02; E04B 7/02

(52) U.S. Cl. CPC E04B 7/18; E04B 7/022; F16M 13/02; F16M 2200/08

(57) ABSTRACT

A platform for mounting an air conditioner on an inclined roof is described. The platform has a substantially rectangular floor, a rear wall depending upwardly and having a horizontal upper edge, and side walls, each said side wall having an inclined upper edge extending from the upper edge of said rear wall to a front corner of the rectangular wall. The platform has a first flange extending from the horizontal upper edge of the rear wall, a second flange extending from the front edge of the floor.

### BACKGROUND

1. Field of the Invention

The present invention relates to the field of building components. In particular, the present invention provides a component for safely and efficiently mounting an air conditioner on a pitched roof.

2. Description of the Related Art

A typical home air conditioner comprises two main elements, a heat exchanger, which is located in the home and may be integrated with the furnace, and a condenser unit, that is located outside the home. In this application, the term “air conditioner”, or “A/C” will be used to refer to the outdoor unit, i.e. the condenser. The air conditioner is often positioned beside a home, on a concrete platform, or attached to the house by a bracket. A disadvantage of this arrangement is that frequently, the condenser is stolen from new house constructions sites, or even from houses with residents, as it can be readily detached, and is expensive. Furthermore, locations close to ground level may not have good air circulation, which is required for efficient operation of the air conditioner.

Brackets have been designed to mount an air conditioner on a sloped roof of a house. This will prevent the A/C unit from being easily stolen, and will permit good air circulation around the unit. Generally, these types of brackets are mounted flat against the roof, and include a horizontally extending platform, on which the A/C is mounted. Braces or struts will be provided at the end of the platform furthest from the roof, to help support the weight of the A/C unit. Disadvantages of these types of brackets are that they are not visually appealing, and that they rely on struts or braces to support the heavy weight of the A/C unit. A broken strut on one side can result in the A/C becoming dislodged. Moreover, an A/C unit mounted on a bracket may be subject to high winds, which may cause it to come loose.

### SUMMARY

The present invention seeks to overcome the disadvantages associated with known A/C roof mount brackets, by providing a platform for mounting an A/C unit in an inclined roof structure. In a broad aspect, the present invention provides a platform for mounting an air conditioner on an inclined roof, said platform having a substantially rectangular floor, a rear wall depending upwardly and having a horizontal upper edge, and side walls, each said side wall having an inclined upper edge extending from the upper edge of said rear wall to a front corner of said rectangular wall, said platform having a first flange extending from the horizontal upper edge of said rear wall, and a second flange extending from the front edge of said floor.

In drawings that illustrate the present invention by way of example.

### BRIEF DESCRIPTION OF THE DRAWINGS

FIG. 1 is a perspective view of a preferred embodiment of the platform of the present invention.

FIG. 2 is a side view of the platform shown in FIG. 1.

FIG. 3 is a front view of the platform shown in FIG. 1.

FIG. 4 is a perspective view showing the platform of the present invention installed between rafters.

FIG. 5 is a perspective view of an alternate embodiment of the platform of the present invention.

### DETAILED DESCRIPTION

Referring to the drawings, an A/C platform or “trough” according to a preferred embodiment of the present invention is shown. It comprises a bottom floor panel 2, rear wall panel 3, and side wall panels 4. The panels are preferably fabricated from aluminum plate, and welded together. Other means to connect the panels together, such as fasteners may be used, or the entire unit may be molded as a single piece. However, welding the panels together provides rigidity and weather proofing, at low cost.

A first flange 5 is provided at the front edge of the floor panel 2, and a second flange 7 is provided at the top edge of rear wall 3. The first 5 and second 6 flanges are angled from the floor panel 2 and rear wall 4 so that the lower surfaces of the flanges 5, 6 are substantially coplanar with the top edges 7 of the side panels 4.

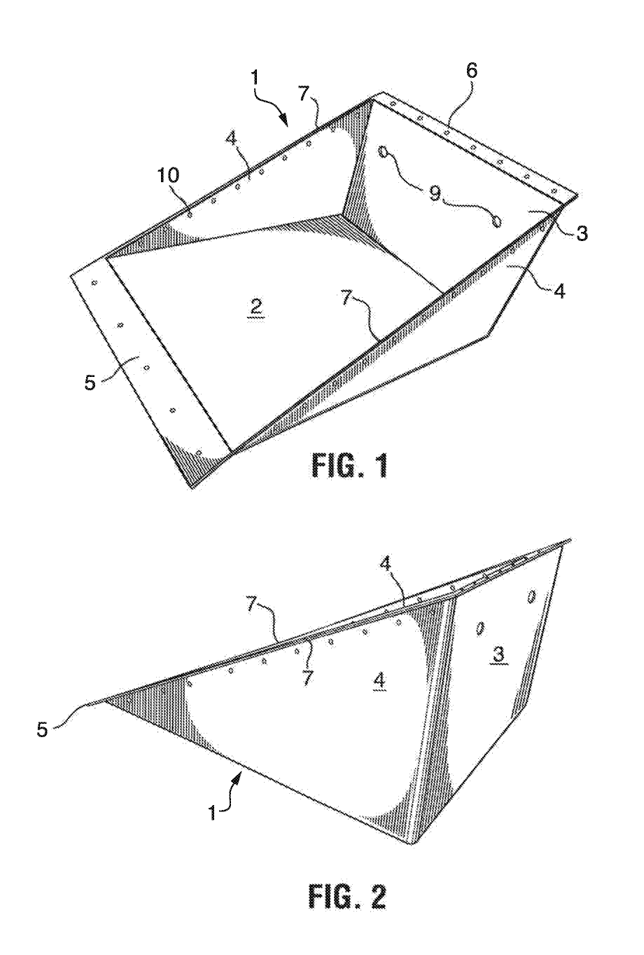

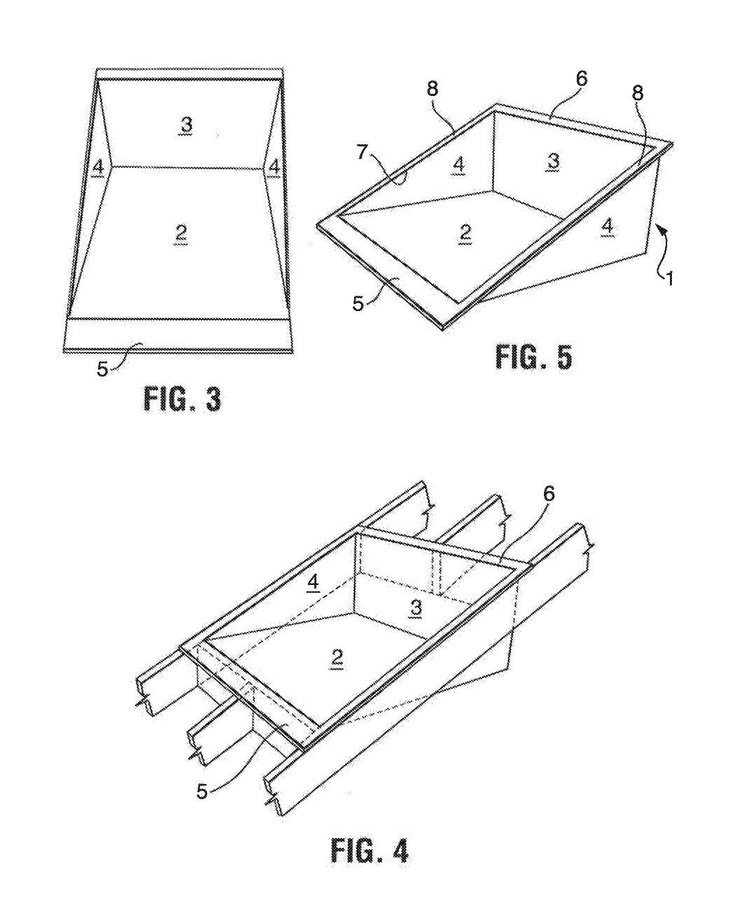

The flanges 5, 6 and side walls 4 are preferably provided with a series of pre-drilled fastener holes (see FIG. 1 only), so that when the platform is set in place in a framed opening between rafters, as shown in FIG. 4, the flanges will lay flat on cross-braces connecting spaced apart rafters, and can be fastened to a roof. In this regard, it is also preferable to form pre-drilled fastener holes along the top edges of the side walls. If desired, side flanges 8 may also be provided along the top edges of the side walls as shown in FIG. 5, for attachment to rafters, and transfer of weight to the top, load-bearing surface of the rafters, but this has been found to be not necessary, and may result in an uneven fit, if the rafters are not perfectly straight.

The floor or rear wall of the platform may be provided with attachment means for firmly attaching the A/C unit to the platform. This may take the form of welded-on bolts, welded on threaded hard points, or the like, as will be a matter of choice to one skilled in the art. The rear wall of the platform is provided with apertures 9 for the passage of electrical wires, coolant tubes, and the like. After installation, the apertures are sealed by silicone or the like.

The side panels are cut at an angle to substantially match the patch of a selected roof, to provide a floor that is horizontal or slightly inclined for drainage. The rear wall will be dimensioned accordingly, to match the height of the rearmost, and therefore highest, part of the side walls.

Referring to FIG. 4, to install the platform of the present invention, it is in most cases necessary to cut a gap in a rafter, and frame a box-like opening in the resulting gap. The top edge of the platform side walls will be aligned with rafter side surfaces, and can be sealed thereto, and then screwed or bolted to the rafter. The first and second flanges will then overlap the box-like framing at the front and rear of the platform, and will be screwed or nailed thereto. Flashing (not shown) will be applied around the top edges of the platform, in a conventional manner, similar to the flashing around a skylight, to prevent entry of water into the house.

The air conditioner can then be mounted on the platform.

What is claimed is:

1. A platform for mounting an air conditioner on an inclined roof, said platform having a substantially rectangular floor, a rear wall depending upwardly and having a horizontal upper edge, and side walls, each said side wall having an inclined upper edge extending from the upper edge of said rear wall to a front corner of said rectangular wall, said platform having a first flange extending from the horizontal upper edge of said rear wall, and a second flange extending from the front edge of said floor.

2. A platform as claimed in claim 1, wherein said flanges are adapted for attachment to a roof surface, whereby said platform can be installed in a recessed manner on said roof.

3. A platform as claimed in claim 2, wherein said floor is set at an angle greater than 90° to said rear wall of said platform, whereby water accumulating in said trough will flow off the front edge of said floor of said platform.

4. A platform as claimed in claim 3, wherein one or more apertures are provided in said platform, for the passage of electrical and fluid conduits.

5. A platform as claimed in claim 4, wherein the flanges, are strong enough to provide structural reinforcement to a roof.

6. A platform as claimed in claim 4, wherein said side walls are adapted to be connected to the rafters of a roof.

7. A platform as claimed in claim 2, wherein one or more apertures are provided in said platform, for the passage of electrical and fluid conduits.

8. A platform as claimed in claim 4, wherein said side walls are adapted to be connected to the rafters of a roof by flanges extending outwardly from said upper edges of said side walls.
